(19) United States
(12) Patent Application Publication
(10) Pub. No.: US 2002/0081982 A1
(43) Pub. Date: Jun. 27, 2002

(54) Portable ear devices

(75) Inventors: Michael Schwartz, Buffalo Grove, IL (US); Jaron Jurikson-Rhodes, Lansdale, PA (US)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Lobeman Group, LLC, Wayne, PA

(21) Appl. No.: 10/079,330

(22) Filed: Feb. 20, 2002

Related U.S. Application Data
(63) Continuation of application No. 09/706,508, filed on Nov. 3, 2000.

(51) Int. Cl. H04B 1/38

(52) U.S. Cl. 455/90; 455/568; 455/575; 381/182

(57) ABSTRACT

A portable radio has a speaker adjustably attached to a flexible arm. A rigid housing is fixedly attached to the flexible arm. When the portable radio is worn, the speaker fits substantially in the concha portion of an ear of the wearer. The flexible arm substantially contours to a back of the individual's ear and the housing has an edge at least partially following the back of the individual's ear. A graphical display may be used to display advertising an image or control information. An ear wearable recording and playback device comprises a speaker for playing recorded voice signals. A microphone is configured to receive voice signals of a wearing individual and a housing contains a recording device. An audio source transmitter system has an audio source for producing an electrical version of an audio signal. An audio source transmitter transmits the audio signal. A radio receives the audio signal. A portable ear wearable receiving and transmission device receives and transmits voice signals to other devices.

This application is a continuation of U.S. patent application Ser. No. 09/706,508, filed on Nov. 3, 2000.

### BACKGROUND

The invention generally relates to communication devices. In particular, the invention relates to portable communication devices.

Communication devices are increasing in popularity, such as portable cassette players and portable radios. A typical portable radio has an antenna for receiving radio frequency signals and an adjustable tuner which can be set to receive a radio frequency of a desired radio station transmission. The received signal of the radio station is sent to a speaker and audio signals are produced by the speaker for use by the listener. An individual using such a radio, typically, tunes the radio to the frequency of a desired radio station. As a result, the individual receives signals from the desired radio station.

As the size of tuners and other radio components is decreasing in both size and cost, both the size and cost of radios as well as other portable communication devices is decreasing. Accordingly, it is desirable to have alternate uses for such devices.

### SUMMARY

A portable radio has a speaker adjustably attached to a flexible arm. A rigid housing is fixedly attached to the flexible arm. When the portable radio is worn, the speaker fits substantially in the concha portion of an ear of the wearer. The flexible arm substantially contours to a back of the individual's ear and the housing has an edge at least partially following the back of the individual's ear. A graphical display may be used to display advertising an image or control information.

An ear wearable recording and playback device comprises a speaker for playing recorded voice signals. A microphone is configured to receive voice signals of a wearing individual and a housing contains a recording device.

An audio source transmitter system has an audio source for producing an electrical version of an audio signal. An audio source transmitter transmits the audio signal. A radio receives the audio signal.

A portable ear wearable receiving and transmission device receives and transmits voice signals to other devices.

### BRIEF DESCRIPTION OF THE DRAWING(S)

FIG. 1 is a flow chart of associating a portable communication device with a broadcast.

FIG. 2 is a flow chart of associating a portable communication device with a broadcast using a timelock.

FIGS. 3A-3C are illustrations of a portable radio configured to fit around an ear.

FIG. 3D is a sideview of the speaker of the radio of FIG. 3C.

FIGS. 4A-4C are illustrations of the portable radio of FIGS. 3A-3B being worn by an individual.

FIG. 5 is a diagram of radio components.

FIG. 6 is a diagram of radio components including a burst transmitter.

FIG. 7A is an illustration of a distributed communication network using a variable frequency transmitter.

FIG. 7B is an illustration of a distributed communication network using single frequency transmitters.

FIG. 8 is an illustration of a distributed communication network using a single frequency.

FIG. 9 is a diagram of radio components including a microphone and transmitter.

FIG. 10A is an illustration of a portable radio with a microphone.

FIG. 10B is an illustration of a portable radio with a microphone incorporated in the housing.

FIG. 11 is an illustration of an automated distributed communication network.

FIGS. 12A and 12B are illustrations of a portable “digital recording” player configured to fit around an ear.

FIG. 13 is a diagram of components of a “digital recording” player.

FIGS. 14A and 14B are illustrations of portable ear radios.

FIGS. 15A and 15B are illustrations of a portable ear recording and playback device.

FIG. 15C is a diagram of portable ear recording and playback device components.

FIG. 15D is an alternate controller for the portable ear recording and playback device.

FIG. 16A is an illustration of an audio player transmission system.

FIG. 16B is a controller for the audio player transmission system.

FIG. 17A is a portable ear radio with a graphical display screen along its side.

FIG. 17B is a portable ear radio with a graphical display screen along its back.

FIGS. 18A and 18B are portable ear receiving and transmission devices.

FIGS. 18C and 18D are illustrations of preferred circuitry for a portable ear receiving and transmission device.

### DETAILED DESCRIPTION OF THE PREFERRED EMBODIMENT(S)

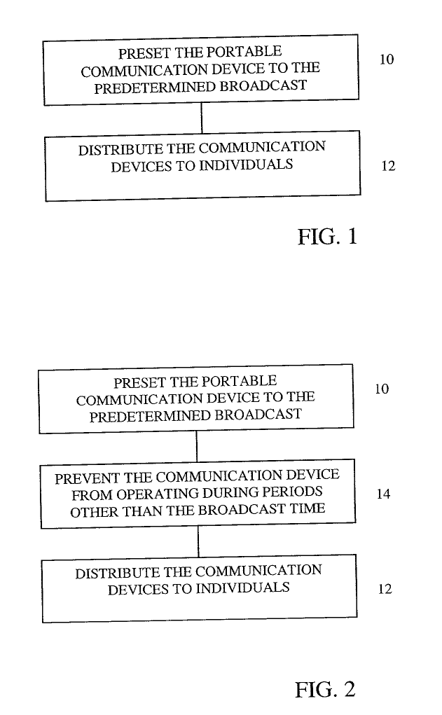

FIG. 1 is a flow chart illustrating associating a portable communication device, such as a portable radio, portable television, personal digital assistant (PDA) or cellular phone, with a predetermined broadcast. When the communication device is a portable radio, the predetermined broadcast may be a radio station broadcast or a radio show broadcast. When the communication device is a portable television, the predetermined broadcast may be a television station broadcast or a television show broadcast. The predetermined broadcast may also be sent in a digital format, such as digital radio, digital cable or the Internet. The predetermined broadcast may be a one time or infrequent event, such as a sporting event or a concert. The predetermined broadcast may also be a periodic event, such as a daily radio show or a weekly television show.

The portable communication device is set to receive the predetermined broadcast, step 10. When the communication device is a radio, the radio is set to the radio frequency of the broadcast. When the broadcast is a television station or show, the communication device is set to the frequency of the television broadcast. When the communication device is used to receive digital signals, such as a PDA device or digital cellular phone, the communication device is preset to decode that broadcast. In addition to decoding, the communication device may also require setting the device to a predetermined frequency and decrypting data, based on the digital media.

After the portable communication devices have been set to receive the broadcast, the communication devices are distributed to individuals, step 12. The distribution may be by selling the devices directly to consumers. To illustrate, radios set to a station broadcasting a football game are sold at the football stadium or at local stores. Additionally, the devices may be distributed by selling them to a broadcaster or organization associated with a broadcast, who will give them away to promote a broadcast. To illustrate, a radio station desires to promote itself. The radio station may give away portable radios preset to its radio frequency. Additionally, the devices may be sold to a sporting event related entity. The devices may be packaged with tickets to the sporting event, such as golf or football.

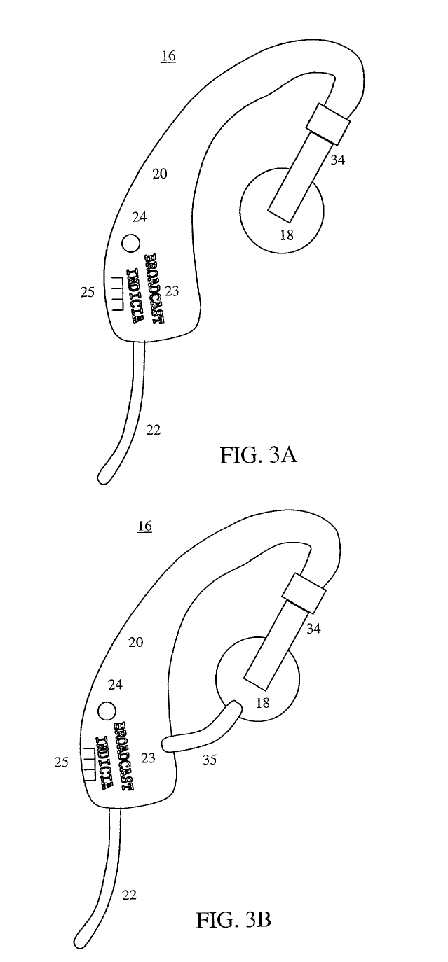

As illustrated in FIG. 2, for broadcasts having an associated broadcast time period, such as a radio show or a television show, the communication device is set to only work during the time period of broadcast of that show, step 14, such as by use of a timer. Essentially, the communication device is locked, “time locked”, to a predetermined operating time. To illustrate, a radio station's morning show is broadcast at 5 a.m. to 11 a.m. on weekdays. The communication device, being a radio, is set to the radio frequency of that radio station and only operates during the hours of 5 to 11 a.m. As a result, only the reception of that radio show can be received on the communication device.

The time lock has other advantages. For portable devices using batteries, limiting the operating period of the communication device extends the life of the battery. The extended life reduces the period between battery replacements or recharges. If the time locked communication devices are sold as disposable units, the extended life increases the time between purchases, reducing the cost to the purchaser, such as a promoter or a broadcast listener.

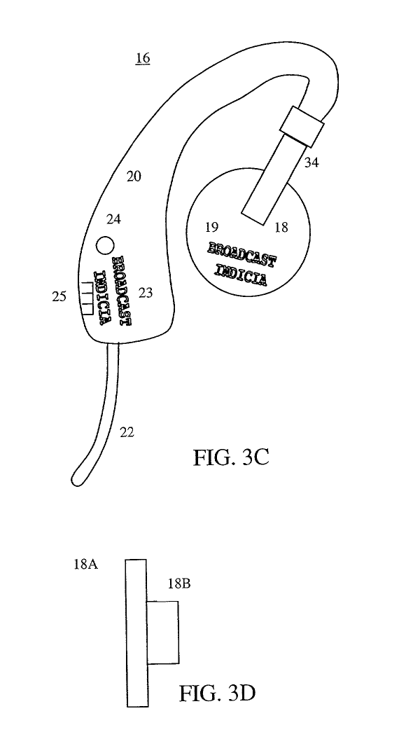

FIG. 3A is one portable radio 16 configured to fit in and around an ear for use in receiving predetermined broadcasts. The radio 16 has a speaker 18, a housing 20, which contains the radio components, and an antenna 22. On the housing 20 is a switch or button 24 for use in turning the radio on and off and controlling the volume. Also as shown, the housing 20 may have an adapter 25 to allow access for setting the radio's frequency. Alternately, if the portable radio 16 is not fixedly set to the predetermined broadcast, the radio 16 may have a knob or button for adjusting the frequency of an adjustable tuner.

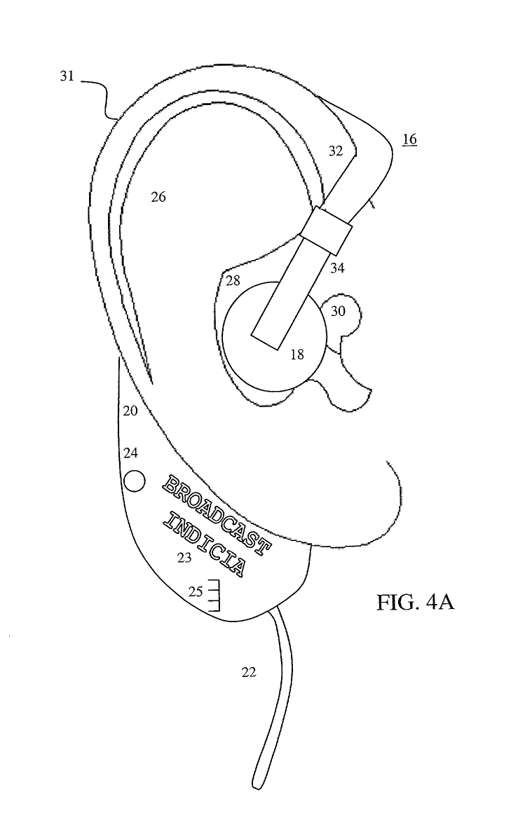

When worn by an individual, as shown in FIG. 4A, the speaker 18 is configured to fit substantially in the concha portion 28 of the ear 26. The speaker directs sound towards the ear canal 30. A hollow rigid cylinder 34 extends from the speaker upwards towards the front 32 of the helix portion of the ear 26. The cylinder 34 contains conductors to the speaker 18. A semi-flexible C-shaped housing 20 contains the major components of the radio. As shown in FIG. 4A, the semi-flexible housing molds to the contour of the top and back of the meeting of the pinna 31 and head. As a result, the radio 16 can be used with individuals with varying ear shape and size. The semi-flexible housing is connected to the rigid member 34. The housing 20 has a narrow portion resting on top of the pinna/head connection. When worn, the narrow portion fits in the gap between the pinna 31 and head. A wider portion follows the back of the pinna/head connection and extends slightly below the ear 26. An antenna 22 projects out of the bottom of the housing for use in receiving radio frequency signals.

Due to this configuration of the radio 16, the radio 16 is held in place even under strenuous listener activity. The radio speaker 18 is biased against the ear concha 28. The narrow portion of the housing 20 is supported by the top of the pinna/head connection and during a shock biases against the pinna 31 and head. The wider portion, which contains most of the radio components and most of the radio's weight, is pulled towards the ground by gravity. The rigid cylinder 34 fixedly attached to the speaker 18 keeps gravity from pulling down the radio 16. Due to the various points of bias and support, the radio can remain in place when worn, even under strenuous activity. The C-shape and wider portion of the housing 20 holds the radio 16 on when the listener experiences an upward jolt. During an upward jolt, the wider portion biases partially against the lower pinna/head connection and the speaker biases against the concha 28. Additionally, as shown in FIGS. 3B and 4B an elastic band may be used to connect the speaker 18 to the wider portion housing. This extra connection allows the radio 16 to remain in place even when an individual is suspended up-side-down. To allow the radio 16 to be used in either the left or right ear 26, the speaker 18 may be rotatable so that it can direct sounds into the ear canal 30 of either ear 26.

As shown in FIGS. 3A-3C and 4A-4C, to better associate the radio 16 with the broadcast, indicia 24 of the broadcast is preferably put on the radio 16. For a radio station broadcast, the indicia 24 may be the radio station's associated frequency and symbol. For a sporting event broadcast, the indicia 24 may be a sports team's logo. Additionally, the indicia 24 may be of an advertiser or a sponsor of the event. The indicia 24 is preferably located such that it is visible when in use by the individual as shown in FIGS. 4A-4C.

Additionally, the speaker 18 can be enlarged to hold broadcast indicia 19 as shown in FIGS. 3C and 4C. As shown in FIG. 3D, one portion 18B of the speaker 18 is configured to fit within that concha 28. A second portion 18A has a larger area for containing the indicia 19. As a result, the area for placing indicia 19 is increased with the speaker substantially fitting within the concha 28.

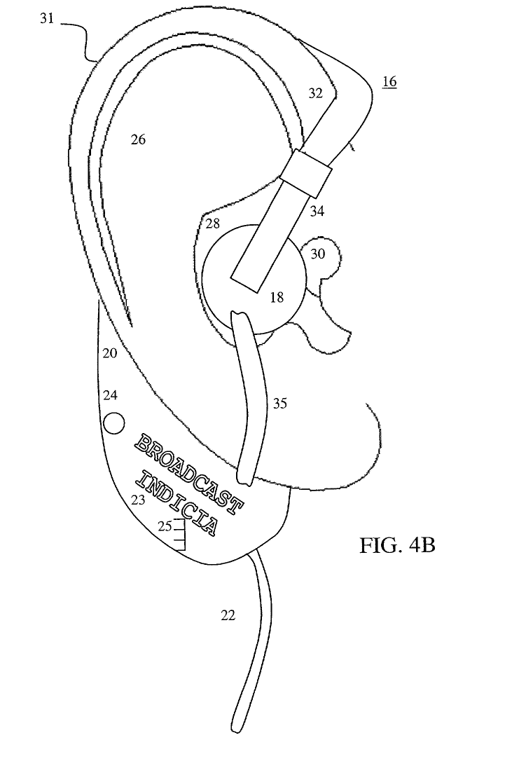

FIG. 5 is an illustration of the circuitry of the radio 16. The antenna 22 receives various radio frequency signals. A tuner 48, which is pretuned to only the frequency of the desired received radio broadcast, is coupled to the antenna 22. The tuner 48 recovers the broadcast signal as a corresponding baseband signal. The baseband signal of the broadcast is amplified by an audio amplifier 40 and sent to the speaker 44. Based on the voltage levels output by the audio amplifier 40, a resistor may be used to adjust the voltage levels. The speaker 44 produces audio signals of the broadcast.

The tuner 48 is powered by a power supply 54, such as a battery. The power supply may also be a rechargeable battery. The supply 54 is coupled to the tuner 48, via a capacitor 52 and either a switch or push button 50. One type of switch or push button would have three states. The three states are an off-state, an on-state with low volume and an on-state with high volume. The low volume state allows a listener to hear things other than the received broadcast, such as conversations or traffic. The high volume state blocks out most external noise allowing the listener to hear primarily the broadcast. The switch/button 50 may have more than two volume states to allow the listener more choices in volume level.

For radios 16 to be distributed widely for a single broadcast, the tuner 48 may be a single frequency tuner. Alternately, a crystal, which will receive signals only at the desired frequency, may be used. A narrow band tuner may also be used. The narrow band tuner compensates for frequency drift in the received signal. A variable tuner may also be used. The variable tuner can be tuned to receive one of many radio frequencies. Preferably, during manufacture, the tuner 48 is set to the frequency of the predetermined broadcast. The tuner 48 is subsequently sealed in the housing 20 of the radio 16. As a result, an individual using the radio 16 will not be able to change the preset frequency.

The variable tuner allows for a single circuit design to be used. The tuner 48 is simply adjusted prior to being sealed in the housing 22. This allows for a single radio design to be used for multiple predetermined broadcasts. One approach to set the frequency, as shown in FIG. 5, uses frequency fixing leads 38. The frequency is fixed by inputting an appropriate signal to an adapter 25, such as a female adapter as shown in FIGS. 3A-3C, 4A-4C, to set the radio's frequency. The variable tuner facilitates mass production of the radios 16 for use with multiple broadcasts. Radios 16 without indicia 19, 23 are mass produced. When an order for radios 16 for a certain broadcast is received, the frequency is set and the indicia 19, 23 is added.

The use of the frequency fixing leads 38 allows the radios 16 to be used for multiple events. After one event, the radios 16 can be reset to a frequency of another event. For instance, the radios 16 may be distributed and collected at a concert one day and reused at a football game another day. New indicia 19, 23 is put on the radios for the new event. Additionally, a new battery can be installed or a rechargeable battery recharged to extend the life of the radio.

Another use of such a portable ear radio is to receive signals over a traditional radio band. The radio may also be used to receive radio stations over the entire radio frequency band, such as AM or FM, or a portion of the band.

For broadcasts having a predetermined broadcast time period, the time lock aspect may be used. As shown in FIG. 5, one approach to providing the time lock is to use a timer 36 and a timer switch 42. The timer 36 is used to determine when the radio should be on or off. The timer switch 42 decouples the supply 54 from the tuner 48 during periods when the radio 16 should not be operational. The period of operation is set during manufacture.

By replacing the tuner with an infrared receiver, infrared signals can be received. Such a system is desirable when a broadcast is only desired to be received in a limited area. One such application is at a place with many points of interest, such as a museum or a scenic outdoor area, where an infrared transmitter would broadcast a description of the points of interest, such as artwork or a landmark, located near the transmitter. The tuner may also be replaced with a receiver capable of receiving other signals in the electromagnetic spectrum, such as light or microwaves.

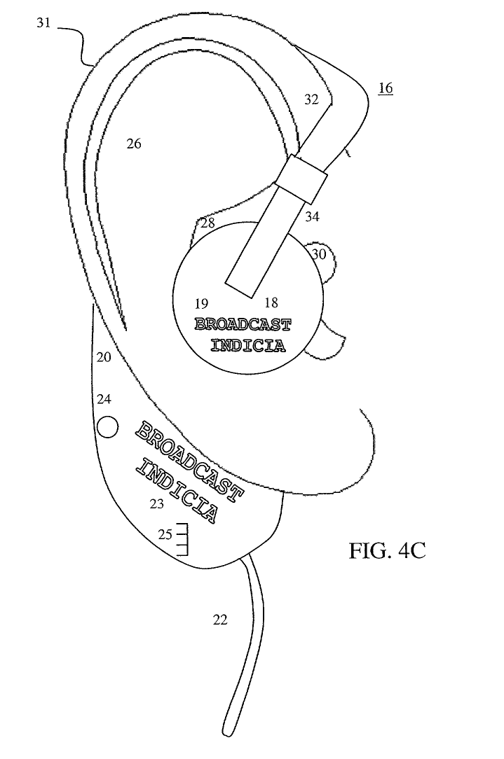

For use in monitoring radio usage, the radio circuitry as illustrated in FIG. 6 may be used. A burst signal transmitter 56 is coupled to the switch/button 50, periodically when the radio is on (in use), the burst signal transmitter 56 produces a burst signal. The burst signal is radiated by the antenna. A radio station may deploy receivers throughout its operating area to receive the burst communications. As a result, the number of listeners using distributed radios and their location can be determined.

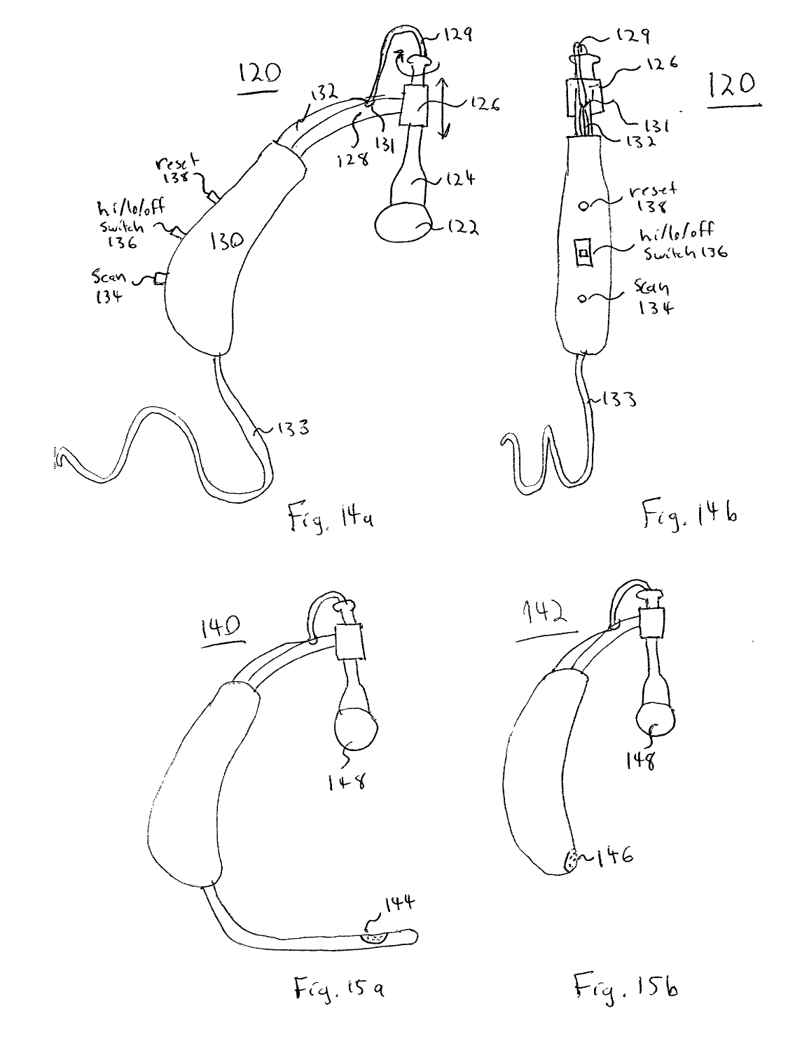

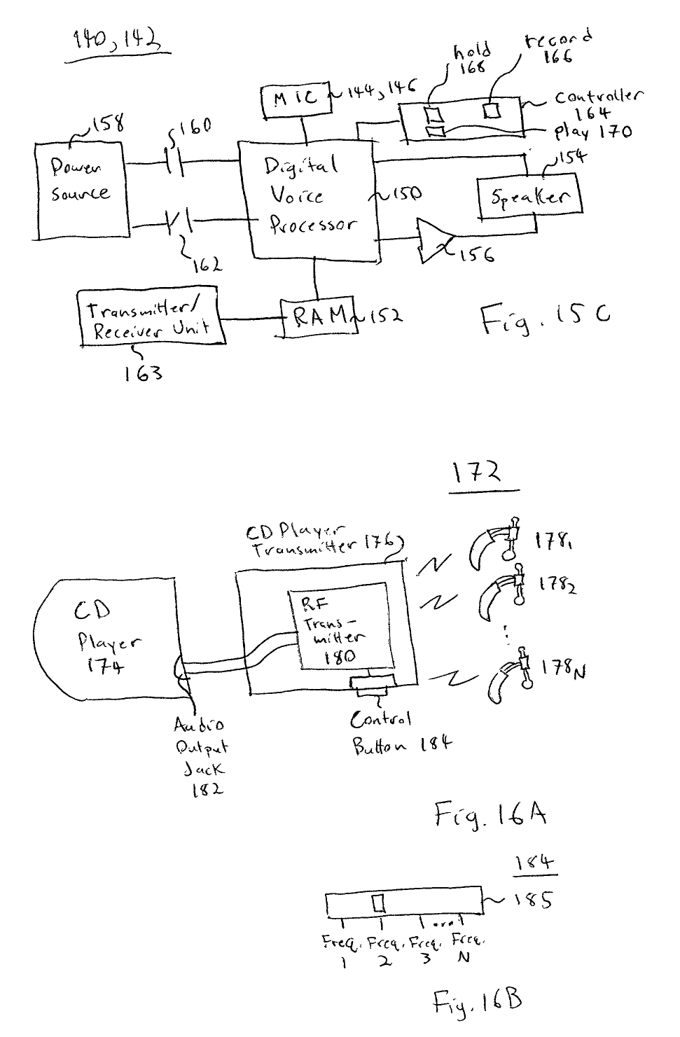

FIGS. 14A and 14B illustrate another portable radio 120 configured to fit in and around an ear. The radio 120 has a speaker 122 attached to a rigid hollow tube 124. The tube 124 extends through a collar 126, which allows the tube 124 and speaker 122 to rotate. The rotation of the speaker 122 allows the radio 120 to be worn in either the left or right ear. The tube 124 also can slide up and down within the collar to allow the radio 120 to be worn by individuals of varying ear size. The collar 126 is fixedly attached to a flexible hollow tube or arm 128 to a rigid arc shaped housing 130. The housing 130 encloses the major components of the radio 120. Optionally, a fin 132 extending out of the hollow tube 128, as shown, can be added to increase the rigidity of the flexible hollow tube 132. The tube 128, although being shown as circular, may be square or another shape. As shown in FIGS. 14A and 15B, a wire 129 connected to the speaker 122 extends out of the hollow tube and is connected to radio components in the housing through a hole in the flexible hollow tube 128.

When worn by a user of the radio 120, the speaker 122 fits substantially in the concha portion 28 of the ear 26. The speaker 122 directs sound towards the ear canal 30. The rigid tube 124 extends from the speaker 122 upwards towards the front 32 of the helix portion of the ear 26. The tube 124 may be slid in the collar 126 to adjust for differing ear sizes. The flexible tube 128 follows the contour of the top and back of the meeting of the pinna 31 and head. The rigid housing 130 has a bottom edge arc shaped so that the housing 130 tends to follow the contour of the pinna/head meeting. One potential advantage to using a rigid housing is that it reduces the cost of the radio 120. Although the top edge is shown as arc shaped, the top edge can be a variety of shapes. As a result, the radio 120 stays in place in and around the ear 26 by the contact of the speaker 122 with the concha 28 and the flexible tube 128 and housing 130 contact with the pinna/head connection. Preferably, a wire-like antenna 133 extends from the housing 130, although other antenna configurations may be used.

Although this radio configuration may be used with a predetermined broadcast, the radio 120 may be used to receive radio signals over the entire or a portion of the radio spectrum. A preferred control button configuration is also shown in FIGS. 14A and 14B. A scan button 134 is used to scan through the radio stations of the spectrum. If the scan button 134 does not wrap around from one end of the spectrum to the other end, a reset button 138 is used to set the radio back to the other end of the spectrum.

To illustrate, a radio 120 receives radio signals from 80 kHz to 100 kHz. The radio 120 starts at 80 kHz and scans up to 100 kHz. After reaching 100 kHz, the radio user can set the radio 120 back to scanning at 80 kHz by pressing the reset button 138.

Preferably, the radio 120 has a switch 136 operating in three states, high volume, low volume and radio off. However, other on/off and volume controls may be used.

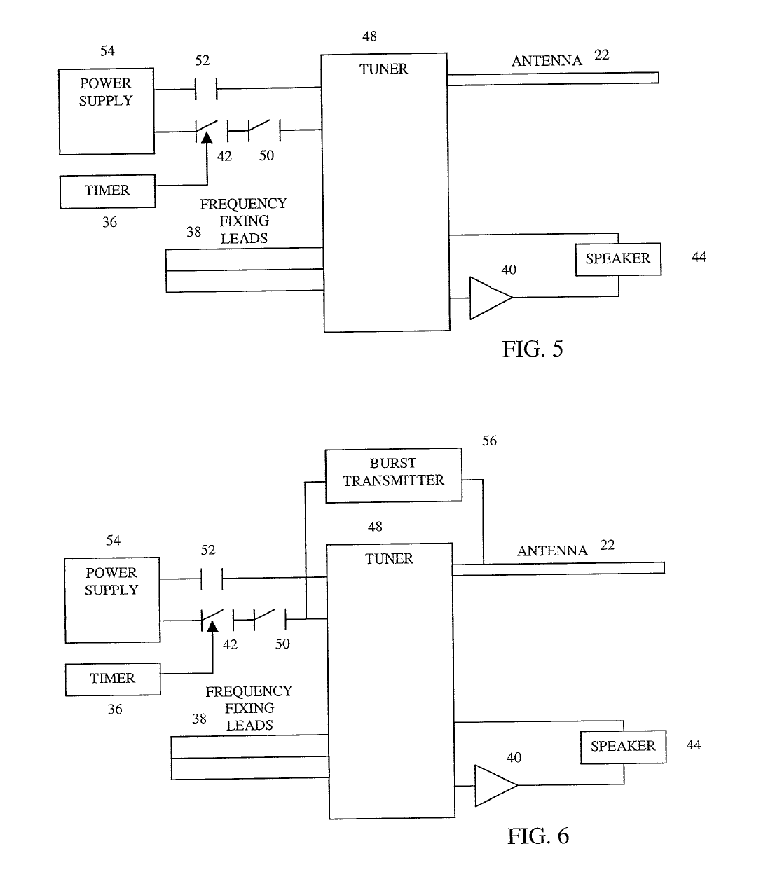

The radio 16 of FIGS. 3A-3C, 4A-4C and 5 could also be used in a distributed communication network, as shown in FIG. 7A. A variable frequency transmitter 66 and associated antenna 68, as shown in FIG. 5, are capable of sending communications on one of a set of preassigned communication frequencies. One set 58 of the radio units 70-74 is fixed to receive communications at one transmitting frequency of the set. Another set 60 of radio units 76-80 is assigned to another transmission frequency of the set and so on for set 64 and its radios 82-84. As a result, an individual at the transmitter 66 can communicate with a selected group of individuals using the preassigned radio receivers. Using the radio 16 of FIGS. 3 to 5 in a work environment, the individuals can have both hands free to perform their tasks while receiving instructions from a central manager. The transmitter may transmit a signal containing voice or other sounds, such as music for the employees' enjoyment. Alternately, the transmitter 66 and radio units 70-84 may be configured to use other portions of the electromagnetic spectrum for communication, such as infrared or light. The transmitter 60 and radio units 70-84 may communicate in either an analog or digital format.

Alternately, as shown in FIG. 7B, multiple single frequency transmitters 65₁-65_{N} may be used. Each single frequency transmitter 65₁-65_{N} transmits to one group of the radio units 58, 60, 64. As a result, each group 58, 60, 64 is uniquely assigned to a single frequency transmitter 65₁-65_{N}.

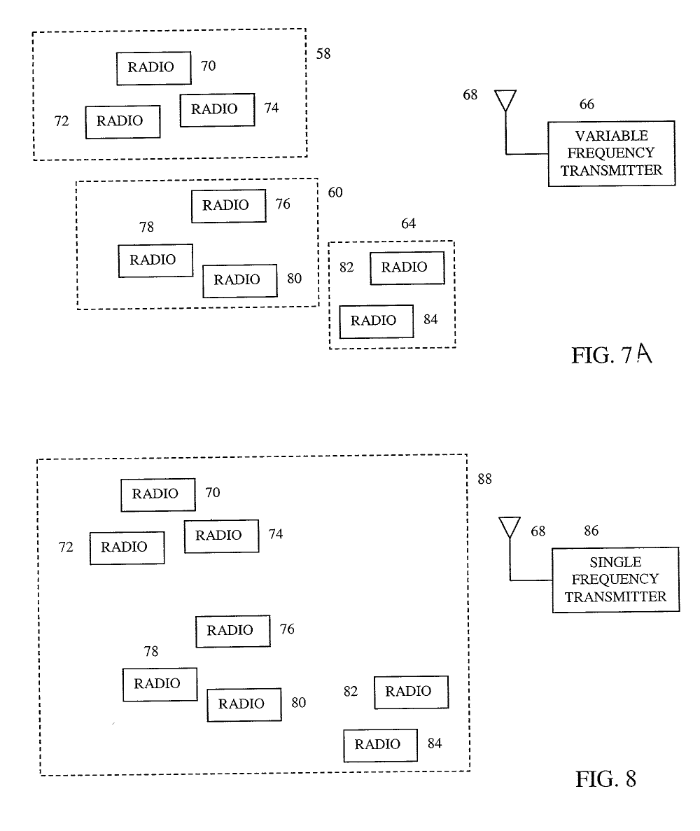

To reduce the complexity of both the transmitter and receivers, the network of FIG. 8 may be used. The radio only transmits signals over a single fixed frequency. All 88 of the radios 70-84 only receive the radio signals over the single frequency.

One application for such a network is a supermarket or retail environment. An individual would speak into a public address system or network 100. The network 100 is coupled to the transmitter 99 which transmits to the radio units 70-74. As a result, only the employees with radio units 70-74 hear the public address messages, not the customers.

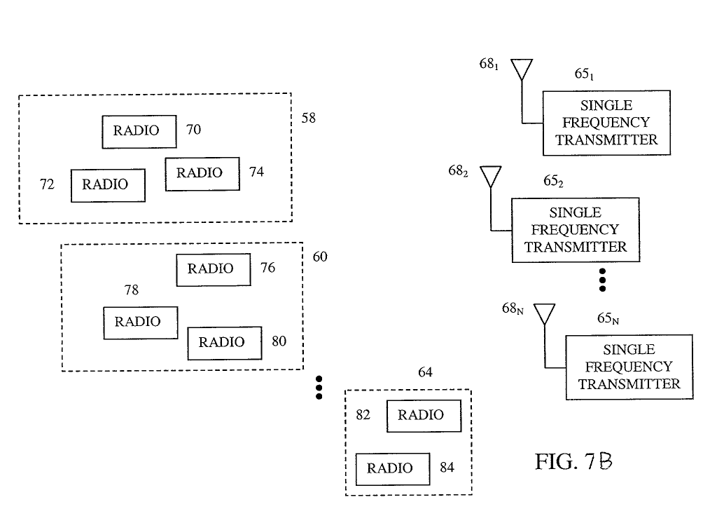

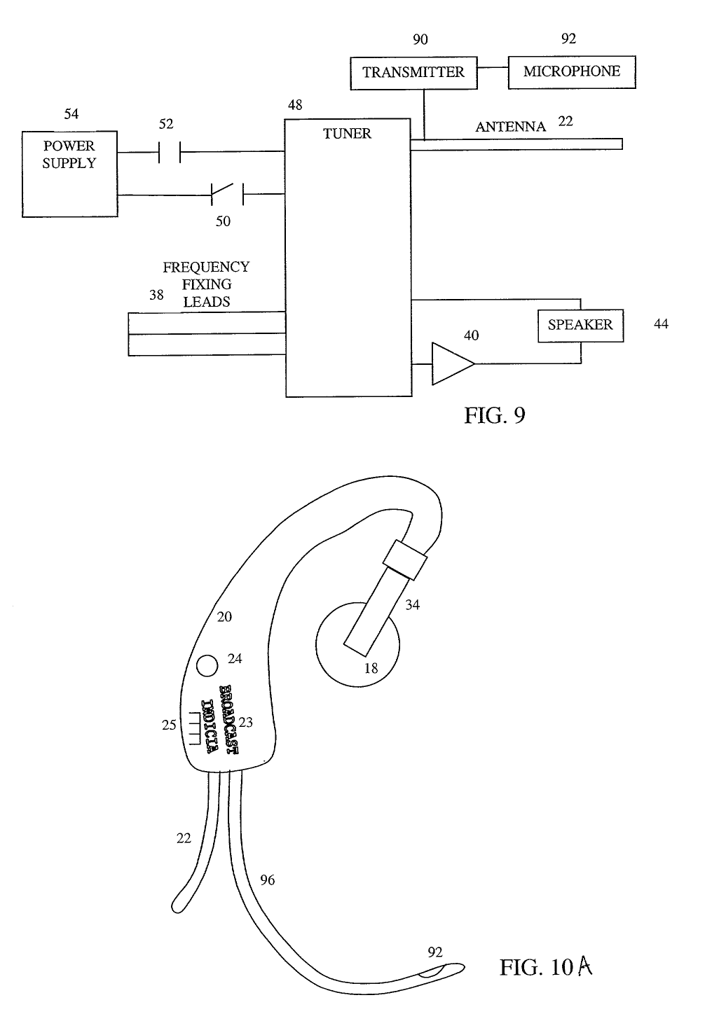

FIG. 9 illustrates radio circuitry for use in a distributed network which allows for uplink communications. The microphone 92 would extend out of the bottom of the radio, as shown in FIG. 10A, and would be configured to receive the voice signals out of the listeners mouth. A semi-rigid support 96 is used to connect the microphone 92 to the radio and support it in front of the listener's mouth. The semi-rigidness allows the microphone position to be adjusted for differing individuals. Alternately, the microphone 92 can be incorporated into the housing as shown in FIG. 10B. A transmitter 90 which is coupled to the antenna 22 converts the voice signal into a radio frequency signal. The antenna 22 radiates the radio frequency signal for reception at the central manager's antenna 68. A receiver is coupled to the manager's antenna 68 to receive the transmitted signal. The uplink signal may be sent over the same frequency that the radio is set to receive signals over in a half duplex mode. Alternately, the uplink signals may be sent over a different frequency so that full duplex communication may be used.

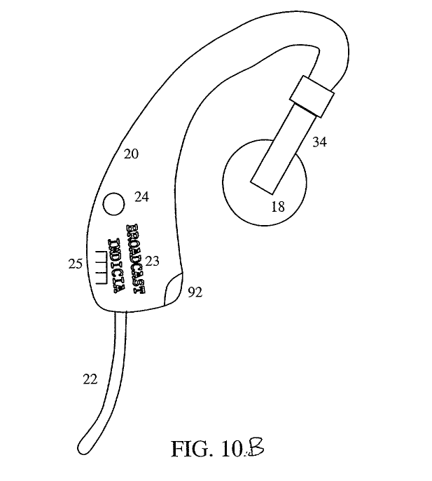

FIG. 11 illustrates an automated distributed network. A central network 100 determines an order to be given. The central network 100 may be a single computer or a company's network. Middleware 98 converts the order into a voice signal, such as by using voice synthesizing software. A transmitter 99 transmits signals to the radio units 70-74. If the distributed network uses radio units set to different frequencies, the middleware indicates which individuals should receive the order. The middleware sets the transmitter 99 to the appropriate frequency.

One application for such a network is in a warehousing environment. Orders are received by the central network 100. The central network 100 via the middleware sends the orders by voice commands to the appropriate warehouse employee. The distributed network is compatible with existing central networks. The commands which would traditionally be sent to an individual are sent to the middleware 98. As a result, an existing network can be used without replacing its existing equipment or software.

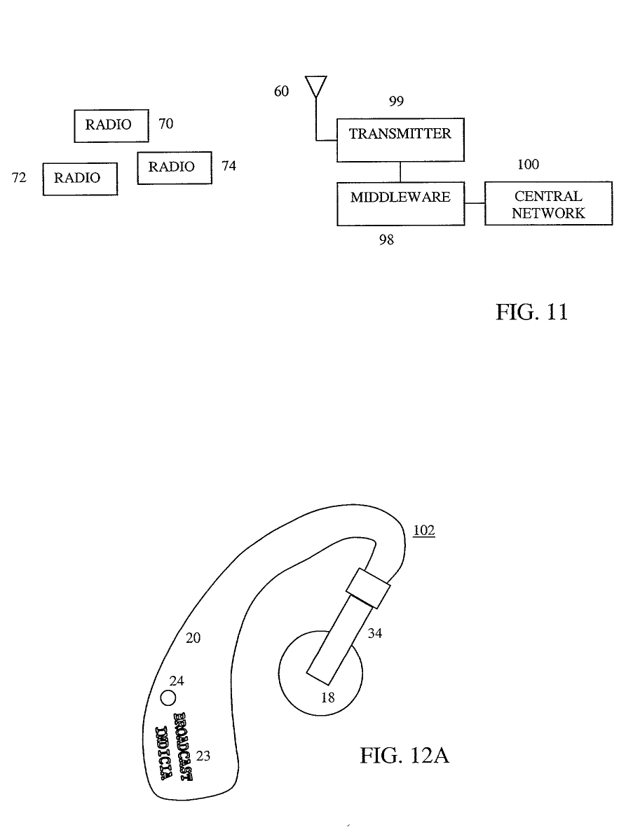

FIGS. 12a and 12b are a “digital recording” player 102, such as an MP3 player, configured to fit around an ear. The “digital recording” player 102 has a speaker 18 which is configured to project audio sounds towards an individual's ear canal 30, when worn. The speaker 18 is fixably attached to a housing 20 which is configured to fit around and behind the ear 26. The housing 20 contains other components of the digital player circuitry. As shown in FIG. 12b, the player 102 may also have an elastic connector 35 to hold the player 102, when an individual is up-side-down.

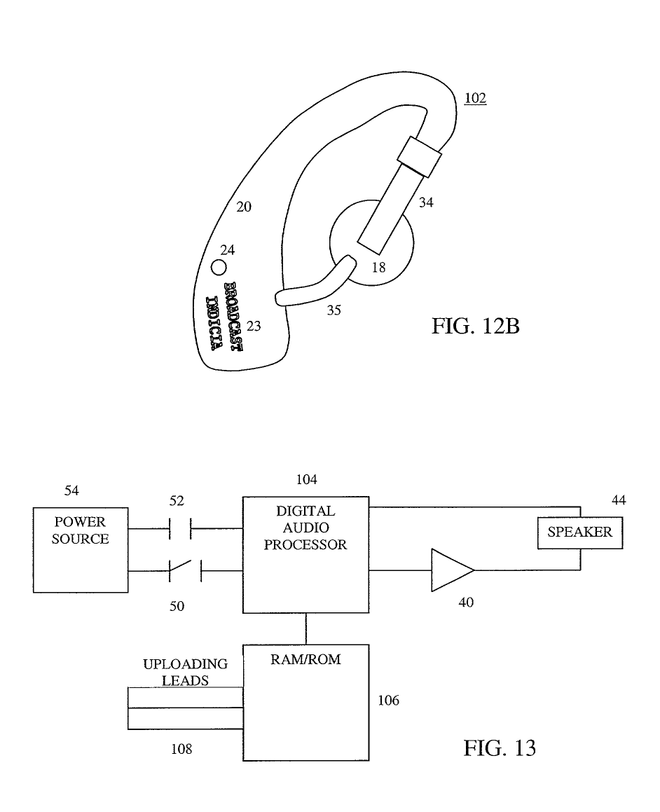

The digital player circuitry is shown in FIG. 13. A digital audio processor 104 is used to convert digital data from the RAM/ROM 106, such as through a serial cable, into a re-creation of the recorded material. One possible format of the digital data is MP3. If a ROM 106 is used, it contains only a single digital recording. In an MP3 player, the ROM 106 would have stored in it a song or set of songs. The listener can only listen to the songs stored in the ROM. The “digital recording” player may have indicia of the “digital recording” on it. If the “digital recording” is a song, the indicia may be of the song's performing artist. If a RAM 106 is used, the uploading leads 108 are used to load the digital recording, such as an MP3 file, into the RAM 106. The uploading may be performed using a computer, or a computer with an internet connection.

The signal produced by the digital audio processor 104 is amplified by an audio amplifier 40. The amplified signal is sent to a speaker 96. The speaker 44 produces audio signals. To power the digital recording player, a power source 54, such as a battery, is used. The source is coupled to the digital audio processor 104 through a capacitor 52 and a switch 50, which may be used to turn the player on and off and control the volume.

FIGS. 15A and 15B are illustrations of portable ear recording and playback devices 140, 142. The recording and playback device 140, 142 has a microphone for receiving the voice of the wearer. As shown in FIG. 15A, the microphone 144 may extend from the portable device 140 in front of the users' mouth. Alternately, the microphone may extend from a wire connected to the portable device. In FIG. 15B, the microphone 146 is part of the portable device 120 and picks up voice signals from the vibrations of the air. Alternately, the microphone 146 can pick up vibrations of the voice signal from parts of the wearer's body, such as the ear or skull.

The portable device 140, 142 can play back the recorded voice signal through the speaker 148 to the user. One application of the portable ear recording and playback device is that the user records a message for an intended recipient. The user passes the recorded message to the recipient, so that the recipient can listen to the message.

FIG. 15C illustrates preferred circuitry for the ear recording and playback device 140, 142. During recording, the microphone 144, 146 sends the received voice signal to a digital voice processor 150. The voice processor 150 stores the voice signal into a memory 152, such as a RAM. During play back, the stored voice signal is reconstructed by the digital voice processor 150 and sent to the wearer through the speaker 154, after amplification by an amplifier 156. The portable device 140, 142 is powered by a power source 158. A capacitor 160, as shown, may be coupled between the power source and the digital voice processor 150. Preferably, an on/off switch 162 is used to turn the device on and off. Additionally, a transmit/receive unit 163 may be used to transfer signals between the devices 140, 142. The transmit/receive unit 163 transmits the recorded voice signal to another receiving device 140, 142. The transmit/receive unit 163 maybe connected to the other device 140, 142 through a wired connector, such as a plug-in cable, or wirelessly connected, such as using infrared, Bluetooth or wireless Ethernet. The receiving unit 163 can play back the transferred voice signal. The transmit/receive unit 163 may also be used to download the recorded voice signal to another source, such as a computer.

A controller 164 is used to control whether the device 140, 142 is in record or play mode. One controller 164 is shown in FIG. 15C. The controller 164 has a record 166, a play 170 button or switch and a hold switch 168 is preferably used in one or two methods.

In a first method, the state of the hold switch 168 only allows the device to operate in exclusively either record or play. When the hold switch 168 is on, the user may play back the recording, but not record. When the hold switch 168 is off, the user may only record, not play.

In second method, when the hold switch 168 is off, the user may either record or play back the recording. When the hold switch 168 is on, the user may only play back the recording.

Another controller 165 is shown in FIG. 15D. A play button 170 and a record button 166 are separated by a three-way switch 165. The three-way switch has three modes: a record mode, a play mode and a hold/off mode. When the switch 165 is in the record mode, the record button 166 can be used to record voice signals. When the switch 165 is in the play mode, the play button 166 can be used to play back recorded voice signals. In the hold/off mode, neither record nor play back can occur.

The preferred application for the portable ear record/playback device, is to store short messages or a short rap/song, although the device 140, 142 may be used for other applications, such as long dictation. In the preferred application, the recording period is limited to a short duration, such as four minutes. Alternately, the recording could be for a longer duration, such as 30 or 60 minutes. The record button 166 is preferably held down by the user to record the message. Holding down the button 166 helps prevent the user from forgetting to stop recording at the end of the message. Alternately, the record button 166 may toggle between a recording mode and a stop recording mode.

In the preferred application, each time a user initiates a new recording, the device 140, 142 starts recording at a start point in the memory 152. Alternately, each time the user initiates a recording, the device 140, 142 can jump to the end of the last recording. Preferably, a jump button is used to jump the recording point to the end of the last recording instead of overwriting the previous recording.

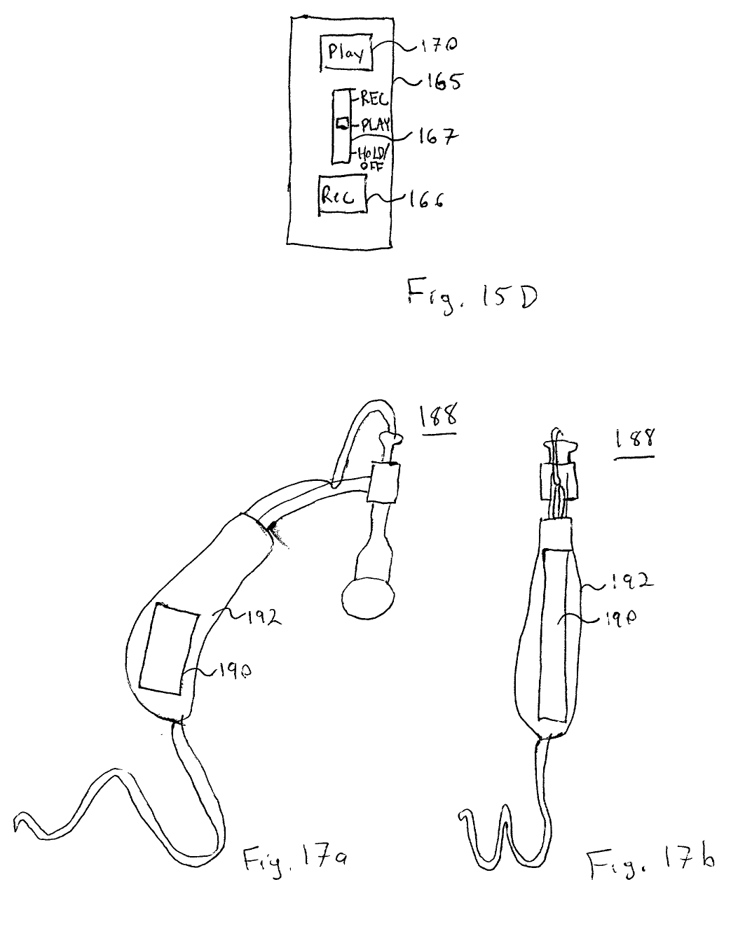

FIG. 16A is an illustration of an audio source transmission system 172. Although the audio source transmission system 172 is preferably used with a CD player, other audio source devices may be used, such as a audio cassette player or MP3 player. The system 172 has an audio source 176, an audio source transmitter 176 and portable ear radio devices 178₁-178_{N}. The audio source 174 outputs an audio signal. The audio source transmitter 176 is coupled to an output, such as audio output jack 182, of the audio source 174. The audio source transmitter 176 is preferably at most 100 millimeters in length, 100 millimeters in width and 40 millimeters in depth, although other size transmitters may be used. A radio frequency transmitter 180 of the audio source transmitter 176 converts the audio signal to a RF signal. The RF signal is converted to an audio signal to be heard by a user of each portable ear radio 178₁-178_{N}.

The RF transmitter 180 may be configured to only transmit the signal over a single frequency. The portable ear radios 178₁-178_{N} are configured to receive at that one frequency. The receiver of the portable ear radios 178₁-178_{N} may be pointed at the particular frequency or have narrow band tuning to compensate for frequency drift. Preferably, the RF transmitter 180 uses a low frequency so that the range of the RF signal is limited, such as to 10 or 50 feet.

To prevent multiple CD player transmitters 176 from interfering with each other, preferably, the RF transmitter 180 can transmit over a set of frequencies. A user can change the transmission frequency by pressing a control button 184. After the user presses the button 184, the transmission frequency changes to another frequency in the set. Alternately, a user uses a switch 185 as shown in FIG. 16B to change between possible frequency sets. The switch is used to select one transmission frequency out of a set of predetermined transmission frequencies. Preferably, the number of predetermined frequencies is at most 25. For use with such a CD transmitter 180, the portable ear radios 178₁-178_{N} preferably scan through the frequency set until the frequency used by the RF transmitter 180 is found. Alternately, the portable ear radios 178₁-178_{N} may be manually set to the CD transmitter frequency.

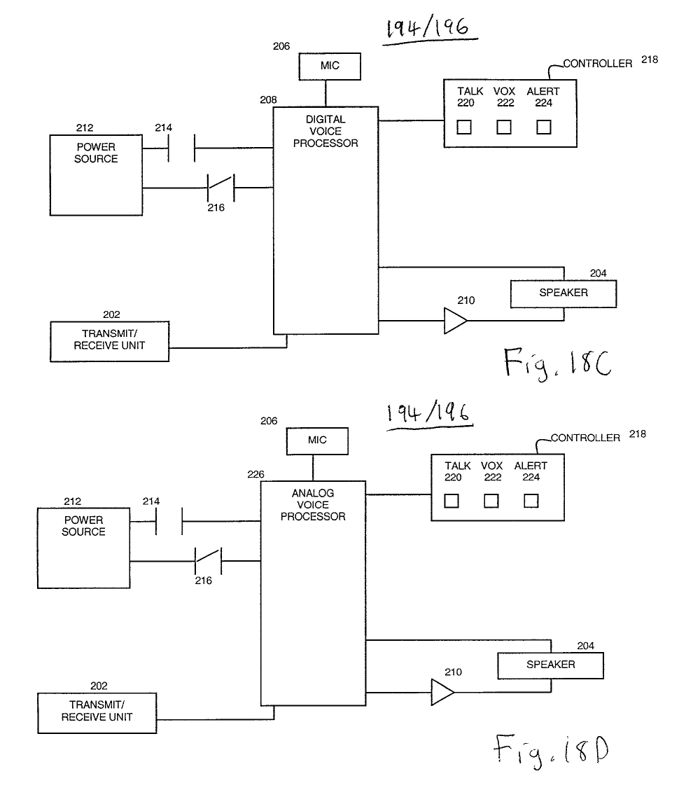

A graphical display screen 190, such as a liquid crystal display screen, may be used with any of the ear device 188 embodiments, as shown in FIGS. 17A and 17B. In FIG. 17A, the screen 190 lies along a side of the ear device housing 192. In FIG. 17B, the screen 190 lies along a back of the housing, which is the edge of the housing opposite the side of the housing facing the ear. The screen 190 of FIG. 17B has the advantage of being visible if the ear radio is worn in either ear.

The screen 190 may be used for control feedback. To illustrate, if the ear device is an MP3 player, the screen 190 displays a number of the current song and its song title. The screen 190 may be used to display an uploaded image. To illustrate, if the ear device 188 is used at a sporting event, a logo of the sporting team or an advertisement may be uploaded and displayed. The displayed image may also be stored in the memory of the ear device 188.

The image displayed on the screen 190 may be received with a radio transmission. To illustrate, along with a radio broadcast, images of advertisers of the broadcast may be sent along with the broadcast and displayed on the screen 190. The transmitted image signal may be multiplexed with the broadcast signal or sent on a separate carrier.

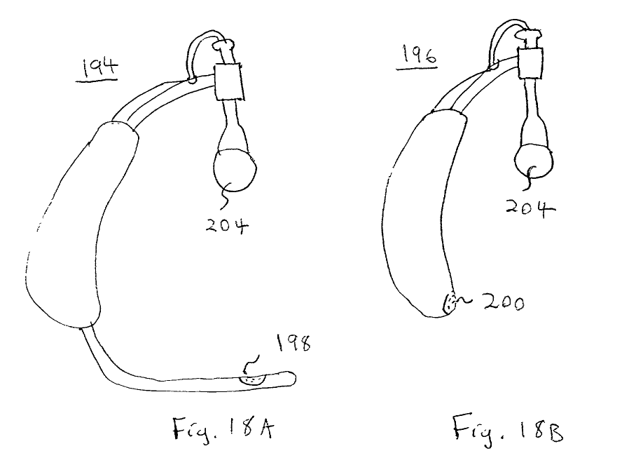

FIGS. 18A and 18B are illustrations of portable ear receiving and transmission devices 194, 196. The portable ear receiving and transmission device 194, 196 has a microphone 198,200 for receiving the voice of the wearer. As shown in FIG. 18A, the microphone 198 may extend from the portable device 194 in front of the users' mouth. Alternately, the microphone may extend from a wire connected to the portable device. In FIG. 18A, the microphone 200 is part of the portable device 196 and picks up voice signals from the vibrations of the air. Alternately, the microphone 200 can pick up vibrations of the voice signal from parts of the wearer's body, such as the ear or skull.

The portable device 194, 196 has a transmit/receive unit 202 as shown in FIGS. 18C and 18D that may be used to transmit voice signals to another receiving device 194, 196. A receiving portable device 194, 196 can play back the transmitted voice signal through the speaker 204 to the user.

FIG. 18C illustrates a preferred circuitry for the portable ear receiving and transmission devices 194, 196. During transmission, the microphone 206 sends the received voice signal to a digital voice processor 208. The voice processor 208 sends the voice signal to the transmit/receive unit 202 to be transmitted to another device 194,196. During receiving, a voice signal is received by the transmit/receive unit 202 and sent to the wearer through the speaker 204, after amplification by an amplifier 210. Alternately during receiving, a processed voice signal is received by the transmit/receive unit 202 and sent to the voice processor 208 to be converted into a voice signal. The voise signal is then sent to the wearer through the speaker 204, after amplification by an amplifier 210. The portable device 194, 196 is powered by a power source 212. A capacitor 214, as shown, may be coupled between the power source and the voice processor 208. Preferably an on/off switch 216 is used to turn the device on and off.

A controller 218 is used to control whether the device 194, 196 is in talk, voice operated transmission (“vox”), alert, or receiving mode. One controller 218 is shown in FIG. 18C. The controller 218 has a talk 220, a vox 222, and an alert 224 button. Alternately, the vox button can be a switch.

The talk button 220 can be used to transmit voice signals to another device 194, 196 using the transmit/receive unit 202. When the talk button 220 is being used, the portable device 194, 196 is prevented from receiving voice signals from another portable device 194, 196. The alert button 224 can be used to transmit predetermined alert signal to another device 194, 196 using the transmit/receive unit 202. When the alert button 224 is being used, the portable device is prevented from receiving voice signals from another portable device 194, 196. When vox 222 is in the vox mode, the portable device automatically transmits voice signals to another device 194, 196 using the transmit/receive unit 202 without requiring use of the talk button 220. When the vox 222 is being used, the portable device is prevented from receiving voice signals from another portable device 194, 196. When neither talk button 220, vox 222 or alert button 224 is being used, the portable device 194, 196 can receive voice signals from another device 194, 196. If the portable device 194, 196 is receiving voice signals, the portable device 194, 196 is not able to transmit voice signals to another portable device 194, 196.

The preferred application for the portable ear receiving and transmission device is to facilitate direct communication between two or more people located in a localized geography. In the preferred application, a digital voice processor 208 is used to allow for digital transmission and receiving of voice signals for the device 194, 196. Alternately, an analog voice processor 226 as shown in FIG. 18D may be used to allow for analog transmission and receiving of voice signals for the device 194, 196.

In the preferred application, the alert button 224 sends a single tone pulse to the transmit/receive unit 202 for transmission to another device 194, 196. The single tone pulse can be used to send Morse code messages. Alternately, the alert button can send any kind of pre-recorded audio signal to the transmit/receive unit 202 for transmission to another device 194, 196.

What is claimed is:

1. A portable radio comprising:
a speaker adjustably attached to a flexible arm;
a housing substantially of a rigid material fixedly attached to the flexible arm; and
wherein when the portable radio is being used by an individual, the speaker fits substantially in the concha portion of an ear of the individual, the flexible arm substantial contours to a back of the individual's ear and the housing having an edge at least partially following the back of the individual's ear.

2. The portable radio of claim 1 further comprising:
a rigid tube extending from the speaker;
a collar fixedly attached to the flexible arm, wherein the rigid tube extends through the collar and rotatably coupled to the collar.

3. The portable radio of claim 2 wherein the rigid tube slidingly engages the collar.

4. The portable radio of claim 3 wherein a wire coupled to the speaker extends through and out of an opposing end of the tube, the wire entering the flexible arm through a hole.

5. The portable radio of claim 1 further comprising a graphical display screen on an edge of the housing opposing the at least partially following the back of the individual's ear edge.

6. The portable radio of claim 1 further comprising a graphical display screen on an edge of the housing facing away from or towards a head of the individual when the portable radio is worn.

7. The portable radio of claim 5 wherein the portable radio receives a transmitted graphical signal of an advertisement and the advertisement is displayed on the graphical display.

8. The portable radio of claim 6 wherein the portable radio receives a transmitted graphical signal of an advertisement and the advertisement is displayed on the graphical display.

9. An ear wearable recording and playback device comprising:
a speaker for playing recorded voice signals, configured to fit in a wearing individual's ear;
a microphone configured to receive voice signals of a wearing individual; and
a housing containing a recording device, the housing configured to fit around the wearing individual's ear.

10. The device of claim 9 wherein the device fits substantially in and around a single ear of the wearing individual.

11. The device of claim 9 wherein when the device is worn by the wearing individual, the speaker fits substantially in the concha portion of the single ear, and the housing having an edge at least partially following the back of the single ear.

12. The device of claim 9 wherein the housing comprises the microphone.

13. The device of claim 9 wherein the microphone extends from the housing.

14. The device of claim 9 further comprising a transmit/receive device so that the device can communicate with other ear wearable recording and playback devices.

15. The device of claim 14 wherein the transmit/receive device communicates using infrared signals.

16. The device of claim 14 wherein the transmit/receive device communicates using radio frequency signals.

17. The device of claim 16 wherein the transmit/receive device communicates using a Bluetooth interface.

18. The device of claim 16 wherein the transmit/receive devices communicates using a wireless Ethernet interface.

19. The device of claim 14 wherein the transmit/receive device communicates using a wired connection.

20. The device of claim 14 wherein the transmit/receive device is used to transfer recorded voice signals to a computer.

21. An audio source transmitter system comprising:
an audio source for producing an electrical version of an audio signal;
an audio source transmitter having an input configured to receive the electrical version and transmitting the electrical version as a radio frequency signal; and
a radio for receiving the radio frequency signal and outputting the audio signal to a user of the radio.

22. The system of claim 21 wherein the radio is a plurality of radios.

23. The system of claim 21 wherein the radio is a radio configured to substantially fit in and around an ear of a using individual.

24. The system of claim 21 wherein the radio is an ear radio and when the ear radio is worn, the speaker fits substantially in the concha portion of a single ear, and the housing having an edge at least partially following the back of the single ear.

25. The system of claim 22 wherein the audio source transmitter capable of transmitting over a set of predetermined frequencies and the radios configured to receive only over the predetermined frequency set.

26. The system of claim 21 wherein the audio source transmitter only capable of transmitting only over a set of predetermined frequencies and the radio is configured to receive only over the predetermined frequency set.

27. The system of claim 21 wherein the audio source transmitter has a switch for selecting at most 25 transmission frequencies.

28. The system of claim 21 wherein the audio source transmitter is at most 100 millimeters in length, 100 millimeters in width and 40 millimeters in depth.

29. An ear wearable transmitting and receiving device comprising:
a speaker for playing voice signals, configured to fit at least partially in a wearing individual's ear;
a microphone configured to receive voice signals of a wearing individual; and
a housing containing a transmit/receive device so that the device can communicate with other transmitting and receiving devices, the housing configured to fit substantially around the wearing individual's ear.

30. The device of claim 29 wherein the other transmitting and receiving devices are ear wearable transmitting and receiving devices.

31. The device of claim 29 wherein the device fits substantially in and around a single ear of the wearing individual.

32. The device of claim 29 wherein when the device is worn by the wearing individual, the speaker fits substantially in the concha portion of the single ear, and the housing having an edge at least partially following the back of the single ear.

33. The device of claim 29 wherein the housing comprises the microphone.

34. The device of claim 29 wherein the microphone extends from the housing.
